(19) United States
(12) Patent Application Publication
(10) Pub. No.: US 2024/0273004 A1
(43) Pub. Date: Aug. 15, 2024

(54) USING SYMBOLIC EXECUTION TO VALIDATE A HARDWARE CONFIGURATION WITH A SOFTWARE IMPLEMENTATION OF PROCESSING RULES

(71) Applicant: INTERNATIONAL BUSINESS MACHINES CORPORATION, Armonk, NY (US)

(72) Inventors: Yoonho PARK, Chappaqua, NY (US); Nikolas IOANNOU, Zürich (CH); GUY LADEN, Tel Aviv (IL); LIRAN SCHOUR, HaZafon (IL); Radu Ioan STOICA, Zurich (CH); Ian Glen NEAL, Ypsilanti, MI (US)

(21) Appl. No.: 18/166,928

(22) Filed: Feb. 9, 2023

(51) Int. Cl. G06F 11/36

(52) U.S. Cl. CPC G06F 11/3608; G06F 11/3684

(57) ABSTRACT

Provided are a computer program product, system, and method for using symbolic execution to validate a hardware configuration with a reference software implementation of processing rules. Symbolic execution is performed of a software model comprising executable code defining logic of a hardware pipeline to produce first symbolic output. Symbolic execution is performed of a reference software implementation of processing rules implemented in the hardware pipeline to produce second symbolic output. The first symbolic output and the second symbolic are compared output to determine a discrepancy between the first and the second symbolic outputs. The discrepancy is reported including report information on a cause of the discrepancy.

### BACKGROUND OF THE INVENTION

### 1. Field of the Invention

The present invention relates to a computer program product, system, and method for using symbolic execution to validate a hardware configuration with a reference software implementation of processing rules.

### 2. Description of the Related Art

To test and debug a hardware pipeline, the developer may run through various test cases to test the logic of the hardware pipeline to determine if it is operating as expected. Hardware developers may utilize Continuous Integration/Continuous Deployment (CI/CD) and Jenkins tools to test hardware and verify the functionality of hardware pipelines. The developer may create automated test suites with the testing tools to automate testing of the hardware with use cases after changes to verify operability of hardware updates. This requires the developer to write code to test the hardware logic.

There is a need in the art for improved techniques to verify the operability of hardware configurations and pipelines.

### SUMMARY

Provided are a computer program product, system, and method for using symbolic execution to validate a hardware configuration with a reference software implementation of processing rules. Symbolic execution is performed of a software model comprising executable code defining logic of a hardware pipeline to produce first symbolic output. Symbolic execution is performed of a reference software implementation of processing rules implemented in the hardware pipeline to produce second symbolic output. The first symbolic output and the second symbolic are compared output to determine a discrepancy between the first and the second symbolic outputs. The discrepancy is reported including report information on a cause of the discrepancy.

### BRIEF DESCRIPTION OF THE DRAWINGS

FIG. 1 illustrates an embodiment of a computing environment to perform symbolic execution to verify a hardware configuration of network packet processing rules.

FIG. 2 illustrates an example of how symbolic input of a network address is used to test a software model of a hardware pipeline against output from a reference software implementation of the network packet processing rules.

FIG. 3 illustrates an embodiment of operations to convert a hardware configuration to a software model comprising executable code defining logic of the hardware configuration and to convert network packet processing rules into a reference software implementation.

FIG. 4 illustrates an embodiment of operations to perform symbolic execution on the software model of the hardware configuration and the reference software implementation of the network packet processing rules to generate symbolic output to compare for discrepancies.

FIG. 5 illustrates a computing environment in which the components of FIG. 1 may be implemented.

### DETAILED DESCRIPTION

Described embodiments provide improved computer technology to test and validate a hardware configuration/pipeline without the developer having to create test cases to try to test all the execution paths of the hardware pipeline. With described embodiments, a symbolic execution engine symbolically executes a software model comprising executable code defining the logic of the processing rules implemented in the hardware pipeline. The symbolic execution engine also symbolically executes the reference software implementation, comprising the software-only configuration of the same network pipeline, which can be considered a ground truth of the processing rules the hardware engine is trying to implement. The symbolic execution engine compares the output of the software model of the hardware pipeline and the ground truth reference software implementation of the processing rules. If the two pipelines differ, then the hardware network pipeline is assumed to contain a bug, as the software-only networking pipeline is considered the ground truth.

With described embodiments, by demonstrating symbolic equivalence between the software model of the hardware pipeline and the reference software implementation of the processing rules, the symbolic execution engine can detect programming bugs as well as bugs in the end-to-end functionality of each pipeline. In this way, the comparison of the symbolic output tests the full processing pipeline rather than the functionality of single components. Further, by using the reference software implementation of the processing rules to serve as the source or ground truth of correctness checks for the hardware pipeline, developers do not have to write additional proofs or formal logic annotations. Instead, the symbolic execution engine can determine discrepancies by comparing the symbolic output.

In embodiments where the processing rules implemented in the hardware pipeline comprise network packet processing rules for a network interface card (NIC), the symbolic execution engine compares packet content to ensure packet modifying operations (e.g., encap/decap) are performed correctly. This allows testing for network packet equivalence as well as for packet actions and routing decisions.

In testing network packet processing rules in a hardware pipeline, the network packets conform to a format consisting of values such as network addresses, flags, and data. The values of the format are replaced by symbolic values in symbolic execution. Thus, the symbolic execution engine does not have to infer anything about the semantic construction of either the hardware or software pipeline, but it only needs to reason about the input and output format of the symbolic packets in performing a comparison operation.

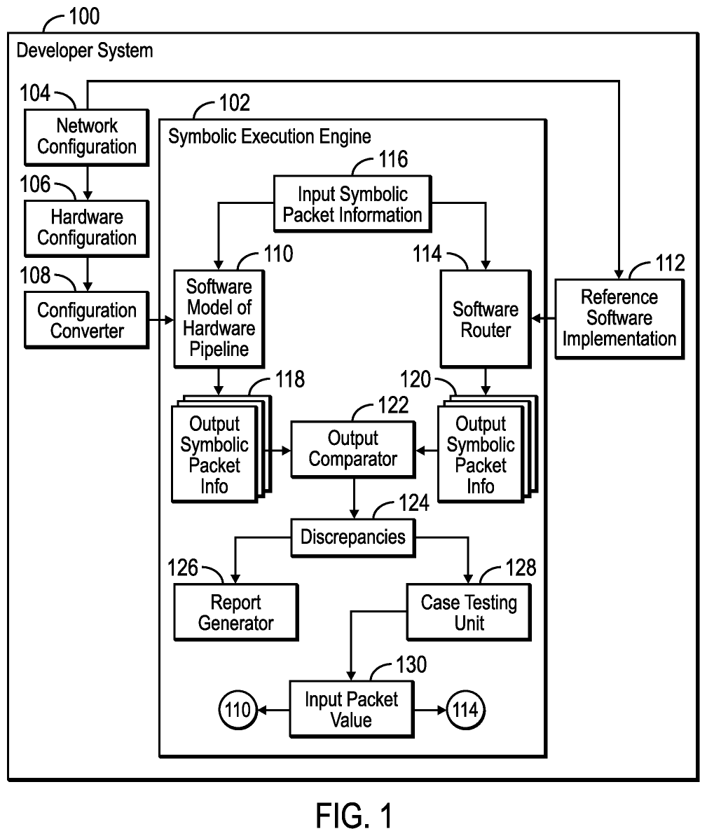

FIG. 1 illustrates an embodiment of a developer system 100 including a symbolic execution engine 102 to test hardware pipelines. In the embodiment of FIG. 1, the hardware pipeline being tested implements network packet processing rules in a network interface card. In alternative embodiments, other types of hardware pipelines in different processing settings may be tested.

A network configuration 104 provides a definition of network packet processing rules to process network packets processed by a hardware configuration 106, also known as the hardware pipeline, implementing the network configuration 104. The hardware configuration 106 may be defined according to a hardware description created when designing the hardware configuration for a hardware pipeline, such as a hardware description language (HDL) or other technique for describing how hardware is configured and programmed. A configuration convertor 108 may convert the hardware configuration 106, defined in the hardware description, into a software model 110 of the hardware pipeline, comprising an executable program that simulates the hardware configuration 106 of the network configuration 104. In certain embodiments, the conversion of the hardware configuration 106 to the software model 110 is automatic. A reference software implementation 112 provides a software coding of the network packet processing rules of the network configuration 104. The reference software implementation 112 integrates with a software router 114. The software router 114 may comprise a driver implemented in an operating system of a user computer having the network interface card (NIC) implementing the hardware configuration 106, and route network packets to the hardware pipeline (NIC) for processing. The software router 114 is modified to route network packets to the reference software implementation 112 of the network packet processing rules, such as by issuing Application Programming Interface (API) calls to the reference software implementation 112 to apply the network packet processing rules.

The symbolic execution engine 102 may input an input symbolic packet 116, comprising symbolic values for any aspect of the packet information and format, including, but not limited to, a network address, payload, and miscellaneous flags and headers that affect packet handling, to both the software model 110 and the software router 114. The software model 110 and software router 114, during symbolic execution, may output respective output symbolic packet information 118 and 120 comprising symbolic network addresses and actions to take for the symbolic network addresses, e.g., accept or deny, on possible execution paths. The output information 118 and 120 may comprise other packet format information, such as payloads and miscellaneous flags and headers. An output comparator 122 compares the outputs 118 and 120 and determines if there are any discrepancies 124 to output. A report generator 126 may generate a report providing information on the output discrepancies 124 and the execution paths on which the discrepancies occurred. Further, the report may visually highlight the execution paths in the code in which the discrepancies occurred as presented in a user interface of a software development program.

A case testing unit 128 may generate an input packet value, such as a network address with numerical values, payload, and miscellaneous flags that affect packet handling, to then provide as input to symbolic execution of the software model 110 and software router 114 to determine output and discrepancies for further troubleshooting. With the embodiment of FIG. 1, the reference software implementation 112 provides a ground truth of the network configuration 104 to validate whether the software model of the hardware pipeline 116 is implementing the network packet processing rules correctly.

In alternative embodiments, the hardware configuration 106 may implement processing rules in contexts other than network packet processing. In such case, the software model 110 and software router 114, which may comprise an implementation of the processing rules, may implement processing rules unrelated to network packet processing, and the output 118 and 120 may comprise symbolic output for variables in the software model 110 and software router 114 that are to be compared on different execution paths.

The arrows shown in FIG. 1 between the components in the developer system 100 represent a data flow among the components.

Generally, program modules, such as the program components 102, 108, 110, 112, 114, 122, 126, 128 may comprise routines, programs, objects, components, logic, data structures, and so on that perform particular tasks or implement particular abstract data types. The program components of the developer system 100 of FIG. 1 may be implemented in one or more computer systems, where if they are implemented in multiple computer systems, then the computer systems may communicate over a network. The program components 102, 108, 110, 112, 114, 122, 126, 128 may be accessed by a processor from memory to execute.

The functions described as performed by the program 102, 108, 110, 112, 114, 122, 126, 128 may be implemented as program code in fewer program modules than shown or implemented as program code throughout a greater number of program modules than shown.

The developer system 100 may comprise one or more computer systems suitable for software development and debugging. The developer system 100 may comprise a physical machine or a virtual machine.

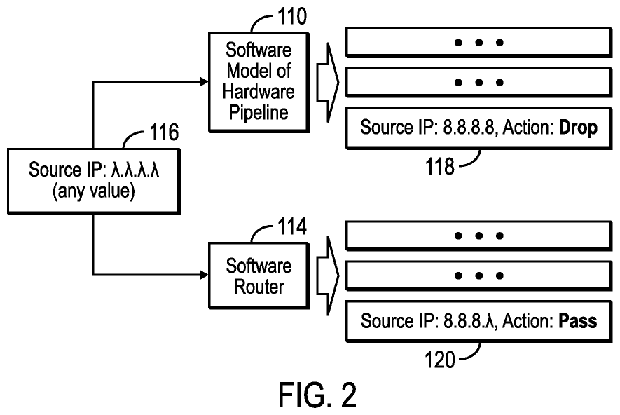

FIG. 2 illustrates an example of how the input symbolic packet 116 has a symbolic network Internet Protocol (IP) address comprised of symbolic values “λ” that are provided as input to symbolic execution of the software model 110 and software router 114 to produce output IP addresses 118, 120, respectively, on different execution paths, which as shown in FIG. 2, have different actions and values on one execution path. In FIG. 2, both the software router 114 and the software model 110 of the hardware pipeline are tested with a symbolic packet (represented by a packet with a source of “any” IP). Of the possible output paths, a discrepancy is found in that the hardware configuration/hardware pipeline 106 drops packets with source IP address 8.8.8.8, but the software router 114 passes all packets in the 8.8.8.0 subnetworks.

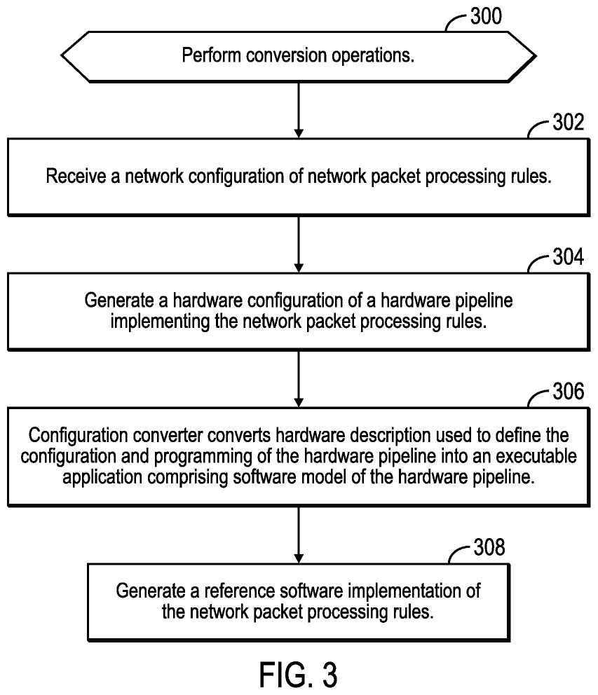

FIG. 3 illustrates an embodiment of operations performed by the configuration converter 108 and other software development tools to generate the software model 110 and the reference software implementation 112 to integrate with the software router 114 during symbolic execution. Upon initiating (at block 300) conversion operations, a network configuration 104 of network packet processing rules, which may be written in a software programming language, is received (at block 302). A hardware configuration 106 of a hardware pipeline implementing the network packet processing rules 104 is generated (at block 304). The hardware configuration 106 may be described according to a hardware description. The hardware configuration 106 may have been previously coded by the hardware pipeline developer using hardware descriptions as part of designing the hardware configuration 106 pipeline to implement the network packet processing rules 104. Hardware descriptions express the hardware configuration and how the hardware will be programmed, and may be implemented in hardware description languages, such as Verilog and VHDL, and in other types of hardware description schemes such as Programming Protocol-independent Packet Processors (P4) and TC Flower classifiers, among others. P4 is an open source, domain-specific programming language for network devices, specifying how data plane devices (switches, routers, Network Interface Cards (NICs), filters, etc.) process packets. The P4 language is used to program Programmable Network Access (PNA) hardware on Field Programmable Gate Array (FPGA) SmartNICs. The hardware description may further be expressed using TC Flower classifiers that provide flows for packet processing. The hardware configuration 106 may have been generated by a hardware programming interface or development tool to convert network packet processing rules, or other processing rules in non-network domains, into the hardware description of the hardware configuration 106.

A configuration convertor 108 may then convert (at block 306) the hardware descriptions of the hardware configuration 106, used to create the hardware pipeline, into an executable software application comprising the software model 110 of the hardware pipeline. For instance, the P4 hardware descriptions of the hardware configuration and programming may be converted into an eBPF style application or the Verilog hardware description language may be converted into a C application of the software model 110.

A reference software implementation 112 of the network packet processing rules, as described in the network configuration 104, may be generated (at block 308) using a software development tool that processes the coded description of the network configuration 104 to produce executable software code. The software router 114 may call the reference software implementation 112 to have the network packet processing rules implemented in the software implementation 112 process a packet. In this way, the software router 114 may route network packets to the reference software implementation 112 for application of the network packet processing rules. Software development tools may be used to modify the software router 114 to invoke the reference software implementation 112 instead of the actual hardware pipeline.

With the embodiment of FIG. 3, the hardware configuration 106 is converted to a software model 110 to simulate the hardware pipeline. The reference software implementation 112 of the network packet processing rules is considered the ground truth of the network packet processing rules 104 because it is easier to debug the direct reference software implementation 112 of the network packet processing rules 104 and because the reference software implementation 112 must contain all networking features, whereas the hardware pipeline in the hardware configuration 106 comprises a fast-path optimization for hardware, which may not implement all networking features. Further, using the reference software implementation 112 to serve as the source of correctness allows comparisons with the software model 110 of the hardware pipeline, rather than requiring developers to write additional proofs or formal logic annotations to test the hardware pipeline in the hardware configuration 106.

In certain embodiments, the reference software implementation 112 is not generated automatically, but may be created and debugged through software engineering practices.

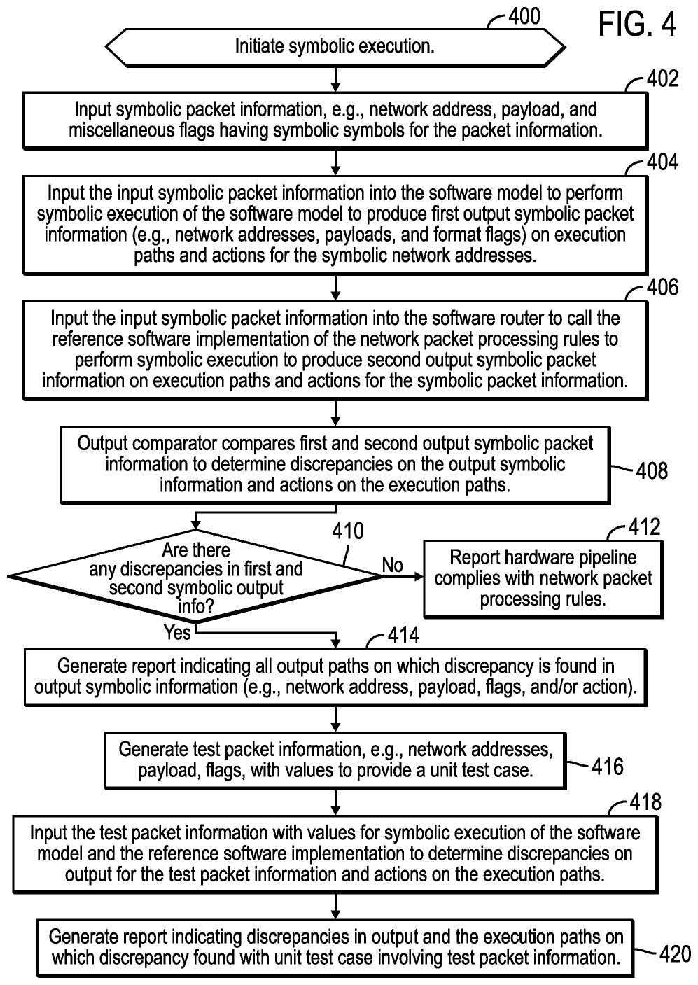

FIG. 4 illustrates an embodiment of operations performed by the symbolic execution engine 102 to validate the hardware configuration 106, as expressed in the software model 110 of the hardware pipeline. Upon initiating (at block 400) symbolic execution, input symbolic packet information 116 is generated (at block 402) comprising symbolic values for packet information, such as a network packet address having symbolic symbols for the address values, symbolic payload, symbolic value for flags that affect packet processing, and other packet related information. The symbolic execution engine 102 inputs (at block 404) the input symbolic packet information 116 into the software model 110 to perform symbolic execution of the software model 110 to produce first output symbolic packet information 118, such as network address, payloads, and packet flags on execution paths, and actions for the output symbolic information, such as deny, accept, malware analysis, etc. The symbolic execution engine 102 also inputs (at block 406) the input symbolic packet information 116 into the software router 114 to call the reference software implementation 112 of the network packet processing rules to perform symbolic execution to produce second output symbolic packet information 120, e.g., symbolic network addresses, symbolic payload, symbolic packet flags and headers, on execution paths, such as all possible execution paths, and actions for the symbolic network addresses. The symbolic input 116 allows testing of all possible or some subset of the execution paths in the software model 110 and reference software implementation 112. During implementation, symbolic execution may only test a subset of possible execution paths in terms of bounding for a testing budget. The output symbolic packet information 118, 120 may be constrained based on the processing path. Multiple output packet information instances may be generated based on the number of unique program paths tested. The symbolic execution may be bounded with some limits on the test coverage, such as possible execution paths and possible symbolic values to consider depending on availability of computational resources.

In the described embodiment, the input 116 and output 118, 120 symbolic packet information 120 may comprise network addresses, payload, and miscellaneous packet flags and headers or other symbolic packet information. In other implementations, the input and output symbolic information may be related to other computer processing environments.

The output comparator 122 compares (at block 408) the first output symbolic packet information 118 and the second output symbolic packet information 120 to determine discrepancies 124 in the output symbolic information and/or actions (e.g., routing decisions) 118, 120 on the different execution paths of the network packet processing rules. If (at block 410) there are no found discrepancies 124, the report generator 126 reports (at block 412) that the hardware pipeline/hardware configuration 106 complies with the network packet processing rules in the network configuration 104. If (at block 410) there are found discrepancies 124, such as in the output network addresses and/or actions, then the report generator 126 generates (at block 414) a report indicating all output execution paths on which discrepancy is found in output packet information and/or action. An example of a discrepancy on an execution path between the software model 110 and reference software implementation 112 is shown in FIG. 2, where the packet information comprises a network address. In certain embodiments, the report may visually highlight the execution paths in the code in which the discrepancies occurred as presented in a computer user interface of a software development program.

The case testing unit 128 upon receiving the discrepancies 124 generates (at block 416) test packet information with numerical values to provide in input packet value 130, or unit test case, that the symbolic execution engine 102 may input into the software model 110 and software router 114 to provide output 118, 120 based on actual numerical test cases. The output 118, 120 based on the input packet value 130 is then inputted (at block 418) to the comparator 122 to find discrepancies on execution paths and report to the developer to use to debug the hardware configuration 106. The report generator 126 may then generate (at block 420) a report indicating discrepancies in the output symbolic packet information 118, 120 and the execution paths on which discrepancies were found with any unit test case involving the input test packet information.

With the embodiment of FIG. 4, the symbolic execution engine 102 explores possible program paths, such as all possible paths or some subset of execution paths if testing is bounded by a budget. This allows testing to determine how the software model 110 of the hardware pipeline and the reference software implementation 112 operate on any packet, including malformed or malicious packets. Further, the report generator 126 of the symbolic execution engine 102 reports the conditions that caused the bug in the executable form of the hardware pipeline 106. This report notifies the developer of this discrepancy and provides details about the execution path which resulted in the discrepancy. Further, the report may visually highlight the execution paths in the code in which the discrepancies occurred as presented in a user interface of a software development program.

The symbolic execution engine 102 case testing unit 128 generates a single concrete example from the output symbolic packet to provide a unit test case to input to the symbolic execution engine 102 to produce a discrepancy involving a real value, which will help the hardware developer understand the specific type of error occurring.

In further embodiments outside of the network packet processing domain, the symbolic packet may comprise symbolic input information of symbolic values for variables processed by the processing rules. The symbolic execution of the software model of a hardware pipeline implementing processing rules provides the symbolic input information to the software model and the reference software implementation of the processing rules. The output of the symbolic execution of the software model, comprising executable code defining logic of a hardware pipeline, is first symbolic output and the output of the symbolic execution of the reference software implementation of the processing rules implemented in the hardware pipeline is second symbolic output. The comparator compares the first symbolic output and the second symbolic output to determine a discrepancy between the first and the second symbolic outputs. In this way, the symbolic execution engine may be extended to validate and compare output for processing rules outside of the network packet processing domain.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, including generating a software model of the hardware pipeline, generating a reference software implementation of processing rules, and performing symbolic execution of the software model and reference software implementation to determine discrepancies indicating errors and bugs in the hardware pipeline.

The computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 501, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

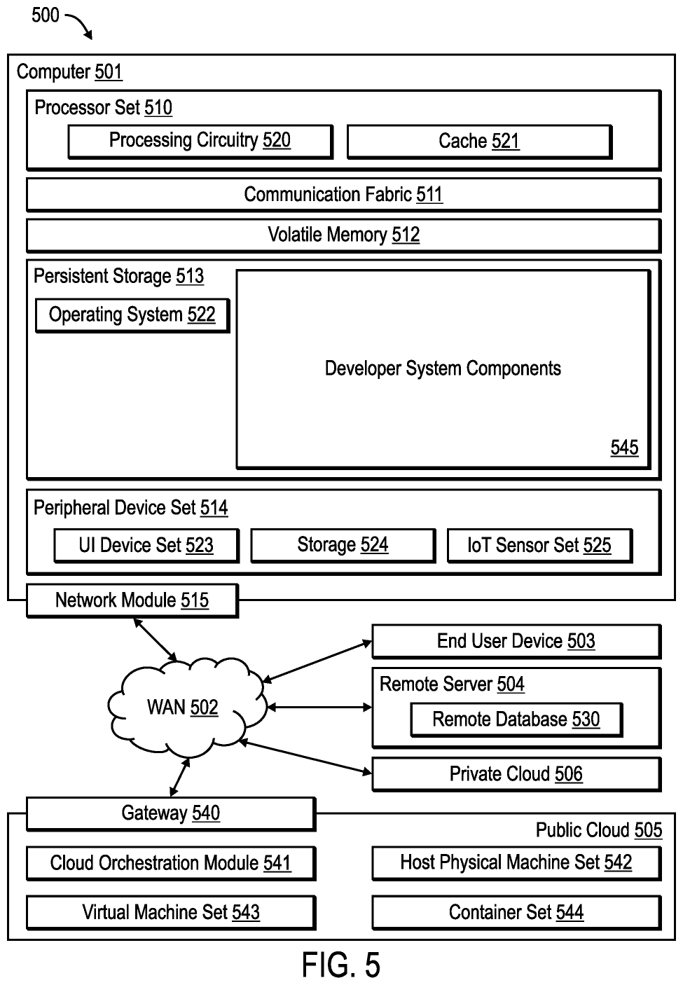

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 545 typically includes at least some of the computer code involved in performing the inventive methods, including, but not limited to, the components in the developer system 100 comprising program components 102, 108, 110, 112, 114, 122, 126, 128 in FIG. 1.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for verifying functionality of a hardware pipeline, the computer program product comprising a computer readable storage medium having computer readable program code embodied therein that is executable to perform operations, the operations comprising:
performing symbolic execution of a software model comprising executable code defining logic of a hardware pipeline to produce first symbolic output;
performing symbolic execution of a reference software implementation of processing rules implemented in the hardware pipeline to produce second symbolic output;
comparing the first symbolic output and the second symbolic output to determine a discrepancy between the first and the second symbolic outputs; and
reporting the discrepancy including report information on a cause of the discrepancy.

2. The computer program product of claim 1, wherein the report information includes information on an execution path that resulted in the discrepancy and visually highlight execution paths at which discrepancies occurred in a computer user interface.

3. The computer program product of claim 1, wherein the operations further comprise:
converting a coding of the hardware pipeline in hardware descriptions into the software model comprising executable code defining logic of the hardware pipeline.

4. The computer program product of claim 1, wherein the performing the symbolic execution of the software model comprises providing symbolic input information to the software model, and wherein the performing the symbolic execution of the reference software implementation of the processing rules comprises providing the symbolic input information to the reference software implementation.

5. The computer program product of claim 1, wherein the operations further comprise:
generating test input comprising values in response to determining the discrepancy;
inputting the test input to the software model to produce first test output;
inputting the test input to the reference software implementation of the processing rules to produce second test output; and
generating output indicating a test discrepancy between the first test output and the second test output and information on an execution path which resulted in the test discrepancy.

6. The computer program product of claim 1, wherein the hardware pipeline is implemented in a network interface card and implements network packet processing rules to process network packets, and wherein the reference software implementation implements the network packet processing rules.

7. The computer program product of claim 6, wherein the performing the symbolic execution of the reference software implementation comprises performing symbolic execution of a software router that calls the reference software implementation of the network packet processing rules to apply the network packet processing rules.

8. The computer program product of claim 6, wherein the first symbolic output comprises first output symbolic packet information on output paths and the second symbolic output comprises second output symbolic packet information on the output paths.

9. The computer program product of claim 8, wherein the comparing the first symbolic output and the second symbolic output comprises comparing the first output symbolic packet information and the second output symbolic packet information and routing decisions with respect to the first and the second output symbolic packet information to determine the discrepancy.

10. The computer program product of claim 8, wherein the operations further comprise:
providing symbolic network packet information having symbolic values as input information to the software model and the reference software implementation of the network packet processing rules, and wherein the first and the second output symbolic packet information comprises symbolic information resulting from possible execution paths in the network packet processing rules.

11. A system for verifying functionality of a hardware pipeline, comprising:
a processor; and
a computer readable storage medium having computer readable program code embodied therein that when executed by the processor performs operations, the operations comprising:
performing symbolic execution of a software model comprising executable code defining logic of a hardware pipeline to produce first symbolic output;
performing symbolic execution of a reference software implementation of processing rules implemented in the hardware pipeline to produce second symbolic output;
comparing the first symbolic output and the second symbolic output to determine a discrepancy between the first and the second symbolic outputs; and
reporting the discrepancy including report information on a cause of the discrepancy.

12. The system of claim 11, wherein the performing the symbolic execution of the software model comprises providing symbolic input information to the software model, and wherein the performing the symbolic execution of the reference software implementation of the processing rules comprises providing the symbolic input information to the reference software implementation.

13. The system of claim 11, wherein the operations further comprise:
generating test input comprising values in response to determining the discrepancy;
inputting the test input to the software model to produce first test output;
inputting the test input to the reference software implementation of the processing rules to produce second test output; and
generating output indicating a test discrepancy between the first test output and the second test output and information on an execution path which resulted in the test discrepancy.

14. The system of claim 11, wherein the hardware pipeline is implemented in a network interface card and implements network packet processing rules to process network packets, and wherein the reference software implementation implements the network packet processing rules.

15. The system of claim 14, wherein the first symbolic output comprises first output symbolic packet information on output paths and the second symbolic output comprises second output symbolic packet information on the output paths.

16. A method for verifying functionality of a hardware pipeline, comprising:
performing symbolic execution of a software model comprising executable code defining logic of a hardware pipeline to produce first symbolic output;
performing symbolic execution of a reference software implementation of processing rules implemented in the hardware pipeline to produce second symbolic output;
comparing the first symbolic output and the second symbolic output to determine a discrepancy between the first and the second symbolic outputs; and
reporting the discrepancy including report information on a cause of the discrepancy.

17. The method of claim 16, wherein the performing the symbolic execution of the software model comprises providing symbolic input information to the software model, and wherein the performing the symbolic execution of the reference software implementation of the processing rules comprises providing the symbolic input information to the reference software implementation.

18. The method of claim 16, further comprising:
generating test input comprising values in response to determining the discrepancy;
inputting the test input to the software model to produce first test output;
inputting the test input to the reference software implementation of the processing rules to produce second test output; and
generating output indicating a test discrepancy between the first test output and the second test output and information on an execution path which resulted in the test discrepancy.

19. The method of claim 16, wherein the hardware pipeline is implemented in a network interface card and implements network packet processing rules to process network packets, and wherein the reference software implementation implements the network packet processing rules.

20. The method of claim 19, wherein the first symbolic output comprises first output symbolic packet information on output paths and the second symbolic output comprises second output symbolic packet information on the output paths.
